(19) United States
(12) Patent Application Publication
(10) Pub. No.: US 2025/0291582 A1
(43) Pub. Date: Sep. 18, 2025

(54) MANAGEMENT OF SOFTWARE DEPENDENCIES

(71) Applicant: Wells Fargo Bank, N.A., San Francisco, CA (US)

(72) Inventor: Preeti Santhanam Iyer, Gilbert, AZ (US)

(21) Appl. No.: 18/602,830

(22) Filed: Mar. 12, 2024

(51) Int. Cl. G06F 8/70; G06F 21/57

(52) U.S. Cl. CPC G06F 8/70; G06F 21/577

(57) ABSTRACT

An example computer system for managing software dependencies can include: one or more processors; and non-transitory computer-readable storage media encoding instructions which, when executed by the one or more processors, causes the computer system to: identify a vulnerability associated with a dependency for a computer program as the computer program is being developed; determine a severity of the vulnerability; and manage the dependency based upon the severity of the vulnerability.

### BACKGROUND

Most software created today depends on various standard libraries to function. These libraries are incorporated as part of the software development process and are referenced during execution of the software. The libraries are often developed and supplied by third parties. This can result in vulnerabilities associated with the use of the software.

### SUMMARY

Examples provided herein are directed to management of software dependencies.

According to one aspect, an example computer system for managing software dependencies can include: one or more processors; and non-transitory computer-readable storage media encoding instructions which, when executed by the one or more processors, causes the computer system to: identify a vulnerability associated with a dependency for a computer program as the computer program is being developed; determine a severity of the vulnerability; and manage the dependency based upon the severity of the vulnerability.

According to another aspect, an example method for managing software dependencies can include: identifying a vulnerability associated with a dependency for a computer program as the computer program is being developed; determining a severity of the vulnerability; and managing the dependency based upon the severity of the vulnerability.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for managing software dependencies.

FIG. 2 shows example logical components of a server device of the system of FIG. 1.

FIG. 3 shows example physical components of the server device of FIG. 2.

### DETAILED DESCRIPTION

This disclosure relates to the management of software dependencies. In the examples provided herein, multiple layers of detection and enforcement of vulnerabilities are provided to manage the lifecycle of the software dependencies.

Such dependencies can include software libraries that are incorporated as part of the software development process. These software libraries can be a collection of resources used during development to implement certain functionality associated with computer programs. These software libraries are often developed by third parties and used to expedite the development of the computer programs.

In the examples provided herein, software dependencies can be detected and governed throughout the lifecycle of software development. This can include one or more of: (i) managing access to dependencies during development; (ii) scanning of dependencies at development milestones; (iii) enforcement of dependencies upon software release; and/or (iv) inventory and analytics associated with dependencies after software release.

There can be various advantages associated with the technologies described herein. For instance, management of the dependencies can mitigate the risks associated with the use of code that is vulnerable to exploitation. In the examples provided herein, this can be accomplished using the multi-layered concept of managing software dependency vulnerabilities. This can include one or more of: policies that manage (block or alert) when vulnerable dependencies are downloaded; continuous feedback on non-compliant dependencies; and/or a centralized repository to house and assess the impact of newly discovered vulnerabilities. This results in computer programs that function correctly for an enterprise.

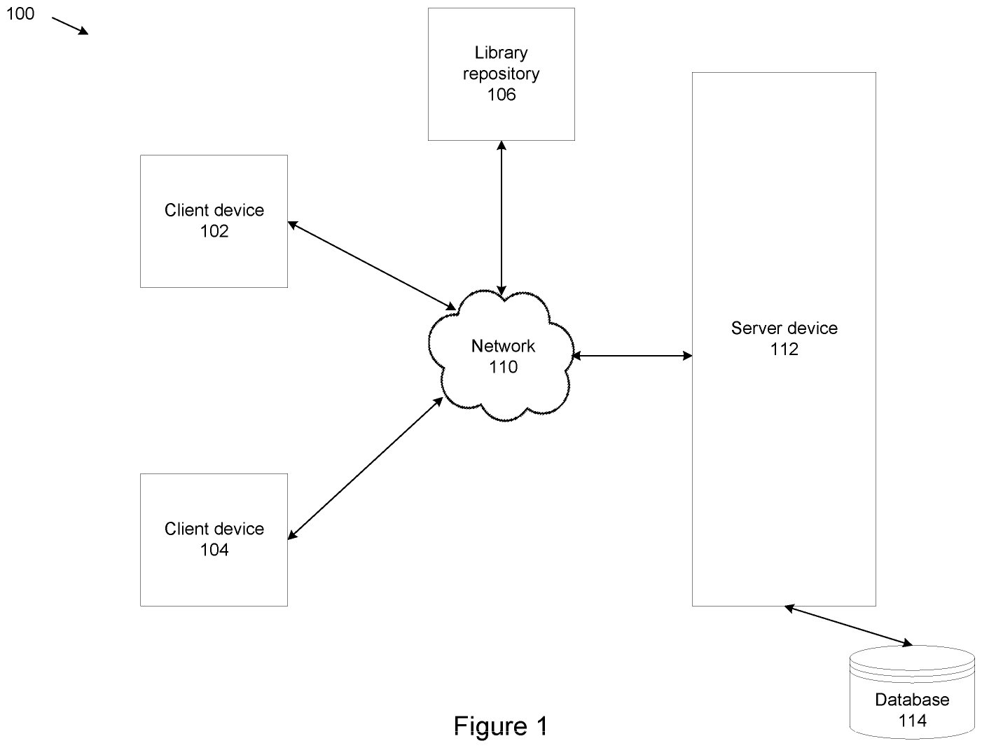

FIG. 1 schematically shows aspects of one example system 100 programmed to manage software dependencies. In this example, the system 100 can be a computing environment that includes a plurality of client and server devices. In this instance, the system 100 includes client devices 102, 104, a library repository 106, a server device 112, and a database 114. The client devices 102, 104 and the library repository 106 can communicate with the server device 112 through a network 110 to accomplish the functionality described herein.

Each of the devices may be implemented as one or more computing devices with at least one processor and non-transitory memory. Example computing devices include a mobile computer, a desktop computer, a server computer, or other computing device or devices such as a server farm or cloud computing used to generate or receive data.

In some non-limiting examples, aspects of the system 100 (e.g., the client devices 102, 104 and the server device 112) are owned by an enterprise, such as a financial institution. The client devices 102, 104 and the library repository 106 can be programmed to communicate with the server device 112 to manage dependencies associated with the software development lifecycle described herein. Many other configurations are possible.

The example client devices 102, 104 are programmed to develop computer programs for the system 100. One non-limiting example of such a computer program is a digital wallet that is used by customers to manipulate funds stored within financial accounts, such as checking, savings, and credit card accounts. This is simply one example, and the system 100 can be used to develop many other types of computer programs. In some examples, the system 100 can be used to develop hundreds or thousands of computer programs that are used by the enterprise.

The example library repository 106 is programmed to store software libraries that can be used by the client devices 102, 104 when developing the computer programs. For instance, the library repository 106 can be hosted by an entity accessible on the Internet that provides software libraries for download. In other examples, the library repository 106 can be a proprietary and/or public repository of software libraries. The library repository 106 can be provided by a party that is unrelated to the financial institution, such as a third-party provider of software.

In the example provided, the client devices 102, 104 access the library repository 106 during the software development lifecycle to download software libraries for the computer programs being developed by the system 100. In one example, the client device 102 accesses the library repository to download a software library that provides functionality associated with accessing a camera on a computing device, such as a smartphone. The client device 102 can use this software library when developing the digital wallet, such as for allowing the digital wallet to generate pictures of physical checks during deposit transactions.

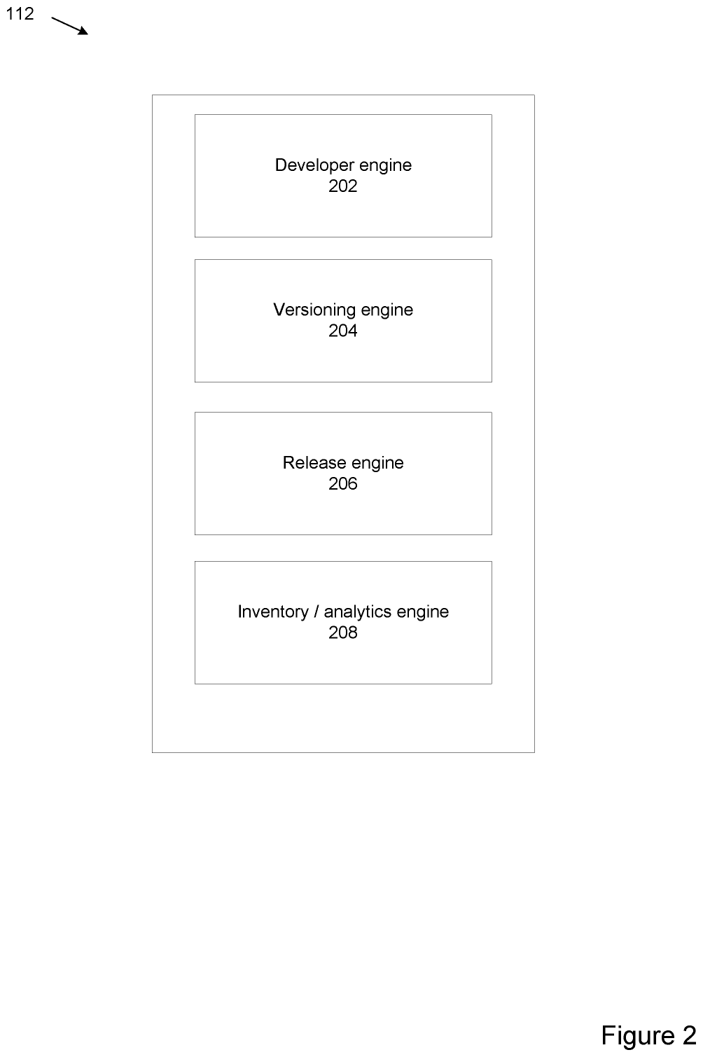

The example server device 112 is programmed to facilitate the software development lifecycle for the system 100. This can include allowing the client devices 102, 104 to check code into and out of the database 114 during development. Further, the server device 112 is programmed to manage the dependencies associated with that code and store information associated with vulnerabilities in the database 114, as described further below with reference to FIG. 2.

The network 110 provides a wired and/or wireless connection between the client devices 102, 104, the library repository 106, and the server device 112. In some examples, the network 110 can be a local area network, a wide area network, the Internet, or a mixture thereof. Many different communication protocols can be used. Although only four devices are shown, the system 100 can accommodate hundreds, thousands, or more of computing devices. For instance, there may be hundreds or thousands of client devices that are used to develop the software in the system 100.

Referring now to FIG. 2, additional details of the server device 112 are shown. In this example, the server device 112 has various logical modules that assist in the software development lifecycle, including the management of dependencies. The server device 112 can, in this instance, include a developer engine 202, a versioning engine 204, a release engine 206, and an inventory/analytics engine 208. In other examples, more or fewer engines providing different functionality can be used.

The example developer engine 202 is generally programmed to setup policies that block (for high vulnerabilities) or alert (for medium/low vulnerabilities) when vulnerable software dependencies are downloaded during software development. For instance, when a developer, using one of the client devices 102, 104, attempts to download a software library from a third party, such as the library repository 106, the server device 112 manages such downloads. Depending on the software library, the server device 112 may block the download or provide an alert associated with the download.

In one example, vulnerabilities associated with dependencies like software libraries are captured and stored in the database 114. When a software library is downloaded by the client devices 102, 104, the server device 112 accesses the database 114 to determine whether the software library is associated with any vulnerabilities.

In one example, the vulnerabilities are either manually identified or automatically identified using known sources. For instance, such vulnerabilities can be accessed from the National Vulnerability Database from the National Institute of Standards and Technology and/or the list of vulnerabilities from the Open Worldwide Application Security Project Foundation. Many other sources are possible.

Further, supervisors can identify when certain dependencies contain vulnerabilities. In some examples, the dependencies can be identified by name (e.g., name of software library), source (e.g., source for dependencies), etc.

For instance, whether added manually or automatically from one of the sources above, each vulnerability can be cataloged in the database 114 to include at least the following information.

| Library name | Vulnerability type | Rating |
|---|---|---|
| Smartphone camera library | Injection | Medium |

In this example, each entry for a vulnerability identifies the specific software library and the type of vulnerability associated therewith. In the example provided, the software library is the “Smartphone camera library” discussed above that allows the computer program to access the camera on a smartphone. The type of vulnerability is an injection vulnerability that is associated with a flaw that occurs when untrusted data is sent as part of a command. In some instances, multiple types of vulnerabilities can be associated with a software library.

Finally, each entry can include the rating, which is an assessment of the criticality of the vulnerability. In the example provided, the rating can be low, medium, and high. In this instance, software libraries having a high rating would be blocked, while those having low and medium ratings would be alerted. Many other scales and configurations are possible.

If the developer engine 202 determines that the software library being downloaded is vulnerable by accessing the database 114, the server device 112 can block the download and/or provide an appropriate alert. For instance, if the software library is rated as a “high” vulnerability, the server device 112 can block the download when attempted by the client device 102, 104 and provide an error message. Similarly, if the rating is “low” or “medium”, the server device 112 allows the download but can provide an alert to the developer and/or a supervisor about the risk(s) associated with the library. For instance, if the “Smartphone camera library” is downloaded by the client device 102, the server device 112 can allow the download and provide the following alert to the developer and supervisor: “The smartphone camera library has a known injection vulnerability. Please be careful when using it in a production environment.”

The example versioning engine 204 is generally programmed to scan and provide feedback on vulnerable software dependencies each time code is changed in the database 114. For instance, as code is developed and checked into the database 114 by the client devices 102, 104, the server device 112 checks the code for any vulnerabilities associated with the software libraries used by the code. This can include vulnerabilities that were missed by the developer engine 202 during development of the code, such as by a developer who downloads a library outside the normal development channels. It can also include libraries that may have been compliant when downloaded during development but are later determined to have vulnerabilities when the software is checked into the code repository at the database 114.

Similar to the above, the versioning engine 204 can be programmed to reject code that is checked in with dependencies having high ratings for vulnerabilities and provide alerts for code that is checked in with dependencies having low or medium ratings. Many other configurations are possible.

The example release engine 206 is generally programmed to scan release builds of the code and implement decisions on whether to release the code to particular environments, such as production environments. More specifically, the release engine 206 can be programmed to scan code that is built and determine any vulnerabilities associated with the dependencies, similar to that described above. The release engine 206 can define one or more rules that dictate how these vulnerabilities are addressed.

For instance, the release engine 206 can be programmed to determine the vulnerabilities as code is built for release and use one or more rules to decide whether to release the code. Such rules can be based on different variables, like policies based on the Common Vulnerability Scoring System (CVSS) Score, licenses, version currency, and technology standards. If the vulnerabilities associated with the dependencies for a release exceed a threshold, the release engine 206 can stop the release and/or issue an alert.

Such rules can be version-controlled and applied to multiple enforcement endpoints using pipelines. The rules can be stored in the database 114, which provides for centralized management of rules.

For instance, the release engine 206 can be programmed to scan an entire release of code and determine vulnerabilities associated with the dependencies for that release. Each vulnerability can be scored based upon the severity of the vulnerability (e.g., low, medium, high as noted above) to create a risk score for the release. If the risk score (i.e., summation of the vulnerabilities) exceeds a threshold, the release engine 206 can be programmed to hold the release.

In one example, when the vulnerabilities exceed a threshold, the release engine 206 refers the release for human intervention. In such a scenario, the release engine 206 reports the vulnerabilities to one or more supervisors, and the supervisors can decide on whether to hold or allow the code to be released.

In some embodiments, the release engine 206 can also be programmed to consider the context associated with the dependencies when calculating the risk score. The context can examine such aspects as how the computer program is used, where the program is used, and/or by whom the program is used. For instance, if the released program will be used in the back office only by employees, a dependency vulnerability may be less severe than for a program used directly by customers. In those instances, the score for each vulnerability can be adjusted by the release engine 206 based upon the context. Many configurations are possible.

The example inventory/analytics engine 208 is generally programmed to generate compliance information for the system 100 based upon the vulnerability information identified by the server device 112. For instance, in one example, the inventory/analytics engine 208 generates a Software Bill of Materials and routes inventory to the database 114 to assess the impact of newly discovered vulnerabilities by the server device 112.

The inventory/analytics engine 208 can generate compliance reports on violations for each type of configured policy, and advanced analytical reporting including causality and correlations. The inventory/analytics engine 208 stores such compliance data in the database 114 and use that information to drive compliance and analytics reporting.

The inventory/analytics engine 208 can also be programmed to generate reports of vulnerabilities and identify trends associated therewith. For example, the inventory/analytics engine 208 can analyze the vulnerabilities associated with all the computer programs that are generated by the system 100 and can identify such trends as whether vulnerability issues are trending up or down, the type or types of vulnerabilities that are being identified, particular computer programs with greater or lesser vulnerabilities, etc. Many configurations are possible.

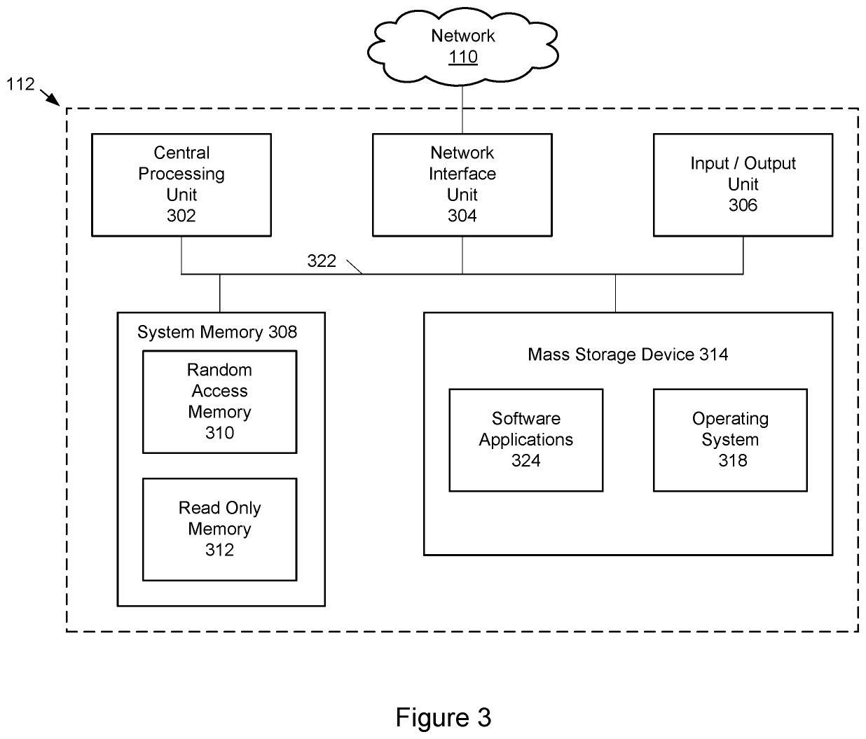

As illustrated in the embodiment of FIG. 3, the example server device 112, which provides the functionality described herein, can include at least one central processing unit (“CPU”) 302, a system memory 308, and a system bus 322 that couples the system memory 308 to the CPU 302. The system memory 308 includes a random-access memory (“RAM”) 310 and a read-only memory (“ROM”) 312. A basic input/output system containing the basic routines that help transfer information between elements within the server device 112, such as during startup, is stored in the ROM 312. The server device 112 further includes a mass storage device 314. The mass storage device 314 can store software instructions and data. A central processing unit, system memory, and mass storage device like that shown can also be included in the other computing devices disclosed herein.

The mass storage device 314 is connected to the CPU 302 through a mass storage controller (not shown) connected to the system bus 322. The mass storage device 314 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 304 connected to the system bus 322. It should be appreciated that the network interface unit 304 may also be utilized to connect to other types of networks and remote computing systems. The server device 112 also includes an input/output controller 306 for receiving and processing input from a number of other devices, including a touch user interface display screen or another type of input device. Similarly, the input/output controller 306 may provide output to a touch user interface display screen or other output devices.

As mentioned briefly above, the mass storage device 314 and the RAM 310 of the server device 112 can store software instructions and data. The software instructions include an operating system 318 suitable for controlling the operation of the server device 112. The mass storage device 314 and/or the RAM 310 also store software instructions and applications 324, that when executed by the CPU 302, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for managing software dependencies, comprising:
one or more processors; and
non-transitory computer-readable storage media encoding instructions which, when executed by the one or more processors, causes the computer system to:
identify a vulnerability associated with a dependency for a computer program as the computer program is being developed;
determine a severity of the vulnerability; and
manage the dependency based upon the severity of the vulnerability.

2. The computer system of claim 1, comprising further instructions which, when executed by the one or more processors, causes the computer system to block the dependency or block release of the computer program based upon the severity.

3. The computer system of claim 1, comprising further instructions which, when executed by the one or more processors, causes the computer system to generate an alert based upon the severity of the vulnerability.

4. The computer system of claim 1, comprising further instructions which, when executed by the one or more processors, causes the computer system to:
block downloading of the dependency;
block code including the dependency during versioning; and
block release of the computer program including the dependency.

5. The computer system of claim 1, wherein the dependency is managed using rules.

6. The computer system of claim 5, wherein the dependency is managed by:
create a risk score associated with all vulnerabilities for the computer program; and
use the rules to hold the computer program based upon the risk score.

7. The computer system of claim 5, wherein the rules are based upon the severity of the vulnerability and a context of the dependency.

8. The computer system of claim 5, wherein the rules are stored in a central database.

9. The computer system of claim 1, comprising further instructions which, when executed by the one or more processors, causes the computer system to generate a compliance report based upon vulnerabilities identified for the computer system.

10. The computer system of claim 9, comprising further instructions which, when executed by the one or more processors, causes the computer system to identify trends associated with the vulnerabilities identified for the computer system.

11. A method for managing software dependencies, comprising:
identifying a vulnerability associated with a dependency for a computer program as the computer program is being developed;
determining a severity of the vulnerability; and
managing the dependency based upon the severity of the vulnerability.

12. The method of claim 11, further comprising blocking the dependency or block release of the computer program based upon the severity.

13. The method of claim 11, further comprising generating an alert based upon the severity of the vulnerability.

14. The method of claim 11, further comprising:
blocking downloading of the dependency;
blocking code including the dependency during versioning; and
blocking release of the computer program including the dependency.

15. The method of claim 11, wherein the dependency is managed using rules.

16. The method of claim 15, wherein the dependency is managed by:
creating a risk score associated with all vulnerabilities for the computer program; and
using the rules to hold the computer program based upon the risk score.

17. The method of claim 15, wherein the rules are based upon the severity of the vulnerability and a context of the dependency.

18. The method of claim 15, wherein the rules are stored in a central database.

19. The method of claim 11, further comprising generating a compliance report based upon vulnerabilities identified for a computer system.

20. The method of claim 19, further comprising identifying trends associated with the vulnerabilities identified for the computer system.
